(19) United States
(12) Patent Application Publication
(10) Pub. No.: US 2022/0197444 A1
(43) Pub. Date: Jun. 23, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Miho ISHIZUKA, Kanagawa (JP)

(73) Assignee: FUJIFILM Business Innovation Corp., Tokyo (JP)

(21) Appl. No.: 17/330,632

(22) Filed: May 26, 2021

(30) Foreign Application Priority Data
Dec. 23, 2020 (JP) 2020-214342

(51) Int. Cl. G06F 3/0482; G06K 9/00; G06K 9/62; G06F 3/0484; G06F 7/08

(52) U.S. Cl. CPC G06F 3/0482; G06K 9/00449; G06K 9/6253; G06F 3/04817; G06F 3/04847; G06F 7/08; G06K 2209/01; G06K 9/6263

(57) ABSTRACT

An information processing apparatus includes a processor configured to: with multiple pieces of form data having attributes of forms being grouped in accordance with form definition information that defines groups respectively with the attributes, receive a change of an attribute of an ungrouped piece of the form data; and re-group the form data in accordance with an attribute responsive to the change and the form definition information.

### CROSS-REFERENCE TO RELATED APPLICATIONS

This application is based on and claims priority under 35 USC 119 from Japanese Patent Application No. 2020-214342 filed Dec. 23, 2020.

### BACKGROUND

### (i) Technical Field

The present disclosure relates to an information processing apparatus and a non-transitory computer readable medium.

### (ii) Related Art

Grouping techniques to group forms are available.

Japanese Unexamined Patent Application Publication No. 2006-209261 discloses a received form job display method. The disclosed received form job display method includes an receiving operation to receive a digital image, a recognition operation to recognize the type of a form from the received digital image, a determination operation to determine whether the recognized digital image is a pre-registered form or unrecognized form, a setting operation to preset a display method of the unrecognized form, and a display operation to display in a list the determined form in accordance with the set display method.

When forms are managed, form data obtained by reading the forms may be grouped. For example, the forms may be grouped on a per attribute basis of the forms identified from the form data in accordance with form definition.

However, the accuracy of recognition of the forms may not be high enough and correct recognition results may not necessarily be obtained. If the attribute of a form is erroneously identified or is not identified at all, the form data is difficult to normally group. To normally group the form data, the user may manually correct the groups of the forms and this job may be time consuming.

### SUMMARY

Aspects of non-limiting embodiments of the present disclosure relate to providing an information processing apparatus and non-transitory computer readable medium reducing, in the case in which form data is difficult to normally group, user workload in grouping the form data in comparison with when grouping of forms is manually corrected.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: with multiple pieces of form data having attributes of forms being grouped in accordance with form definition information that defines groups respectively with the attributes, receive a change of an attribute of an ungrouped piece of the form data; and re-group the form data in accordance with an attribute responsive to the change and the form definition information.

### BRIEF DESCRIPTION OF THE DRAWINGS

Exemplary embodiment of the present disclosure will be described in detail based on the following figures, wherein:

FIG. 1 illustrates a configuration of an information processing apparatus of the exemplary embodiment;

FIGS. 2A through 2D illustrates examples of grouping of form data on the information processing apparatus of the exemplary embodiment;

FIG. 3 is a block diagram illustrating a hardware configuration of the information processing apparatus of the exemplary embodiment;

FIG. 4 is a flowchart illustrating a flow of a grouping process of the information processing apparatus of the exemplary embodiment;

FIG. 5 is a flowchart illustrating a flow of the grouping process of the information processing apparatus of the exemplary embodiment;

FIG. 6 is a flowchart illustrating a flow of the grouping process of the information processing apparatus of the exemplary embodiment;

FIG. 7 illustrates an example of form definition information of the information processing apparatus of the exemplary embodiment;

FIGS. 8A through 8E illustrate examples of the grouping with no attached file performed on the information processing apparatus of the exemplary embodiment;

FIGS. 9A through 9I illustrate examples of the grouping with an attached file present on the information processing apparatus of the exemplary embodiment;

FIG. 10 illustrates an example of a list screen of the information processing apparatus of the exemplary embodiment;

FIG. 11 illustrates an example of the list screen of the information processing apparatus of the exemplary embodiment;

FIG. 12 illustrates an example of a change of serial numbers on the information processing apparatus of the exemplary embodiment;

FIGS. 13A through 13D illustrate an example of a change operation of the serial numbers on the information processing apparatus of the exemplary embodiment;

FIGS. 14A through 14C illustrate an example of a start position in the grouping on the information processing apparatus of the exemplary embodiment;

FIG. 15 illustrates the grouping of the form data with an exclusion flag on in the information processing apparatus of the exemplary embodiment;

FIGS. 16A through 16D illustrate the behavior of a movement button on the information processing apparatus of the exemplary embodiment;

FIGS. 17A through 17E illustrate an example of a method that expresses groups together on the information processing apparatus of the exemplary embodiment;

FIGS. 18A and 18B illustrate an example of display of the groups on the information processing apparatus of the exemplary embodiment;

FIG. 19 illustrates an example of a modification screen on the information processing apparatus of the exemplary embodiment; and

FIG. 20 illustrates an example of re-grouping performed based on modified form definition information on the information processing apparatus of the exemplary embodiment.

### DETAILED DESCRIPTION

Exemplary embodiment is described with reference to the drawings. Like elements and operations are designated with like reference numerals throughout the drawings and the discussion thereof is not duplicated. Dimensions of the drawings are exaggerated for convenience of explanation and different from actual proportion thereof.

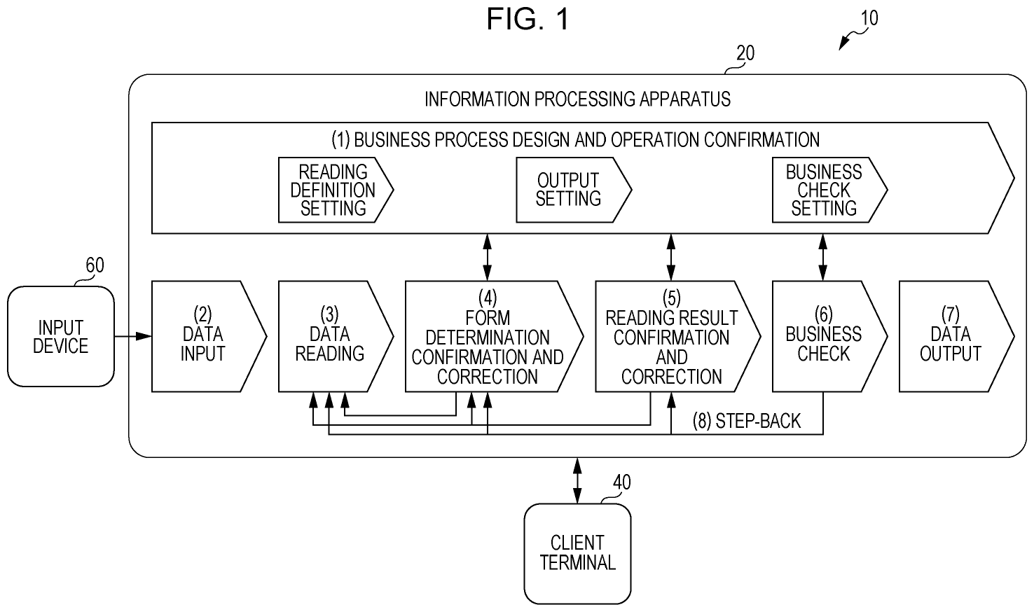

FIG. 1 illustrates the configuration of a form system 10 of the exemplary embodiment.

Referring to FIG. 1, the form system 10 includes an information processing apparatus 20, client terminal 40, and input device 60. These devices are communicably interconnected to each other via a communication network (not illustrated). The communication network may include the Internet, local-area network (LAN), and/or wide-area network (WAN).

The information processing apparatus 20 controls a series of operations including performing an OCR (optical character recognition) process on image data of a document including multiple forms input via the input device 60 and outputting the results of the OCR process to a predetermined output destination. According to the exemplary embodiment, the information processing apparatus 20 is a server computer. However, the information processing apparatus 20 may be a personal computer (PC) or a smart phone. Specific configuration and operations of the information processing apparatus 20 are described below.

The client terminal 40 transmits to the information processing apparatus 20 a variety of instructions related to the OCR process. The instructions include an instruction to start reading information on the image data and an instruction to display read results of the information on the image data. The client terminal 40 also displays a variety of information including the results of the OCR process that the information processing apparatus 20 has performed in response to the variety of instructions received, and a notification related to the OCR process. For example, the client terminal 40 may be a general-purpose computer, such as a server computer or a personal computer (PC). Although a single client terminal 40 is illustrated in FIG. 1, multiple client terminals 40 may also be used properly such that different client terminals 40 operate for different purposes.

The input device 60 inputs to the information processing apparatus 20 the image data serving as a target of the OCR process. The input device 60 may be a general-purpose computer, such as a server computer or a PC, or an image forming apparatus having a scan function, printer function, and fax function. Not only the input device 60 but also the client terminal 40 may input the image data to the information processing apparatus 20.

The configuration of the form system 10 is described below.

In the form system 10, the information processing apparatus 20 performs the OCR process on the image data input via the input device 60 and outputs the results of the OCR process to a predetermined output destination.

In the OCR process, the information processing apparatus 20 controls a variety of operations including a business process design and operation verification operation (1), data input operation (2), data reading operation (3), form determination confirmation and correction operation (4), reading result confirmation and correction operation (5), business check operation (6), data output operation (7), and step-back operation (8). According to the exemplary embodiment, the OCR process includes not only a reading operation to read characters and symbols from the image data but also a post-operation operation, such as a correction operation to characters.

The information processing apparatus 20 automatically performs the business process design and operation verification operation (1), data input operation (2), data reading operation (3), business check operation (6), and data output operation (7) as examples of control operations. The form determination confirmation and correction operation (4) and reading result confirmation and correction operation (5) are received as examples of control operations when the user inputs them using the client terminal 40. The step-back operation (8) as an example of control operations may be automatically performed by the information processing apparatus 20 or accepted when the user inputs the step-back operation (8) via the client terminal 40.

In the business process design and operation verification operation (1), job rules are produced. The job rules include reading definition setting, output setting, and business check setting. For example, in the reading definition setting, a read range in which information on the image data is read is set in the data reading operation (3). Specifically, a definition of reading an item value as a value to the right of an item extracted as a key may be set. For example, in the output setting, a file format and an output destination of output data to be output in the data output operation (7) are set. In the business check setting, a format, such as an input item in a form serving as a detection target and the number of inputtable characters, in the business check operation (6) is set.

In the data input operation (2), the image data is received from the input device 60. The input image data is registered as a job that serves as an execution unit in the data reading operation (3).

In the data reading operation (3), the information on the image data in the job is read by using a job rule of the job to be executed. The job rule is selected by the user from among the job rules produced in the business process design and operation verification operation (1). For example, in the data reading operation (3), the determination of the form (hereinafter referred to as a “form determination”) is performed on the image data in the job and a character and symbol within the read range are read.

In the form determination confirmation and correction operation (4), the image data in the job is grouped into a record indicating a form in the job in accordance with results of the form determination performed in the data reading operation (3). In the form determination confirmation and correction operation (4), the client terminal 40 is caused to display the group and user confirmation and correction are accepted from the client terminal 40.

In the reading result confirmation and correction operation (5), the results of reading the character and symbol in the read range in the data reading operation (3) are displayed and user confirmation and correction to the read results are accepted.

In the business check operation (6), an error in a prior operation is detected in accordance with the business check setting included in the job rule of the job. The job rule is selected by the user from among the job rules produced in the business process design and operation verification operation (1). The detection results may be displayed to the user.

In the data output operation (7), output data is produced using the output setting included in the job rule of the job. The job rule is selected by the user from among the job rules produced in the business process design and operation verification operation (1). The produced output data is output to a predetermined output destination.

In the step-back operation (8), processing steps back from an operation performed in the OCR process by one or more operations. For example, using the client terminal 40, the user may issue an instruction to perform the step-back operation (8) in the middle of the form determination confirmation and correction operation (4) or the reading result confirmation and correction operation (5). Typically, an instruction of the step-back operation (8) may be issued by the client terminal 40 of an administrator in response to results of an administrator check performed between the business check operation (6) and the data output operation (7).

In the OCR process, the business process design and operation verification operation (1) is performed prior to the data reading operation (3), namely, prior to the start of the operation of the form system 10. Alternatively, the business process design and operation verification operation (1) may be performed in the middle of the operation of the form system 10 that performs the data reading operation (3) or subsequent operation. For example, a job rule produced in the business process design and operation verification operation (1) prior to the operation of the form system 10 may be appropriately corrected in response to the results of the reading result confirmation and correction operation (5) with the form system 10 operating.

The form determination confirmation and correction operation (4) of the information processing apparatus 20 is described in detail below.

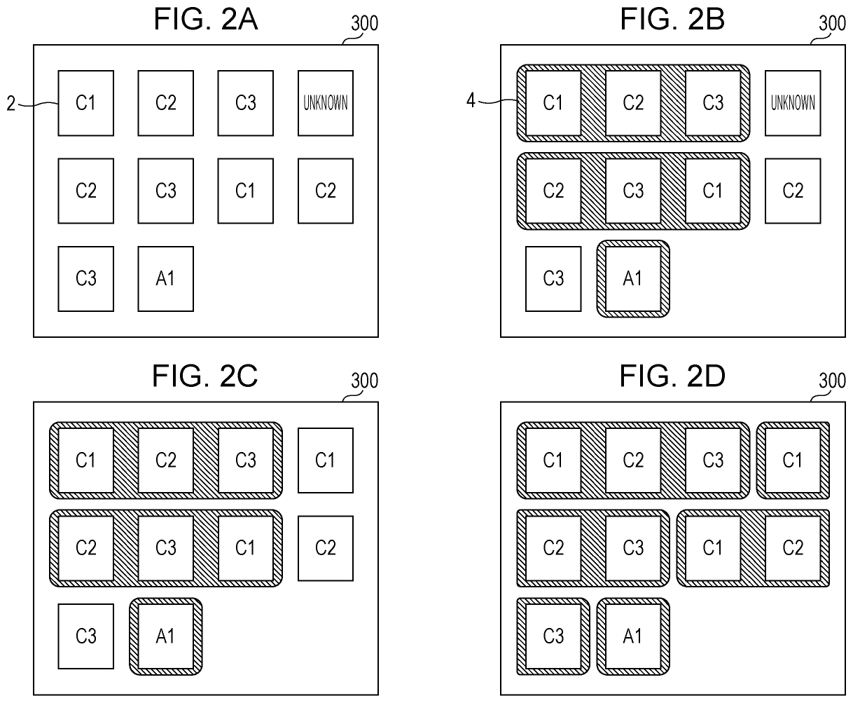

FIG. 2 illustrates the grouping of form data on the information processing apparatus 20 of the exemplary embodiment.

The form data has an attribute of a form. The form data corresponds to the image data on which the form determination is performed in the data reading operation (3) in FIG. 1.

The grouping refers to grouping the form data in accordance with the attribute and form definition information 100.

The attribute refers to a form class, attached file, exclusion flag, and/or serial number.

The form class refers to a combination of the type of a form and a page number of the form. For example, the type of form may be a document, such as transportation expense report or loan application. The page number of the form is a page number of a document including multiple sheets. If the type of the form is A and the page number is 1, the form class is designated “A1.” For example, “C2” represents a form class indicating that the form class is C and the page number is 2. In the following discussion, the form data of a form class A1 is designated form data A1. The form data having unknown form class is referred to as unknown form. In the drawings of the disclosure, the form data having unknown form class is simply referred to as “unknown.”

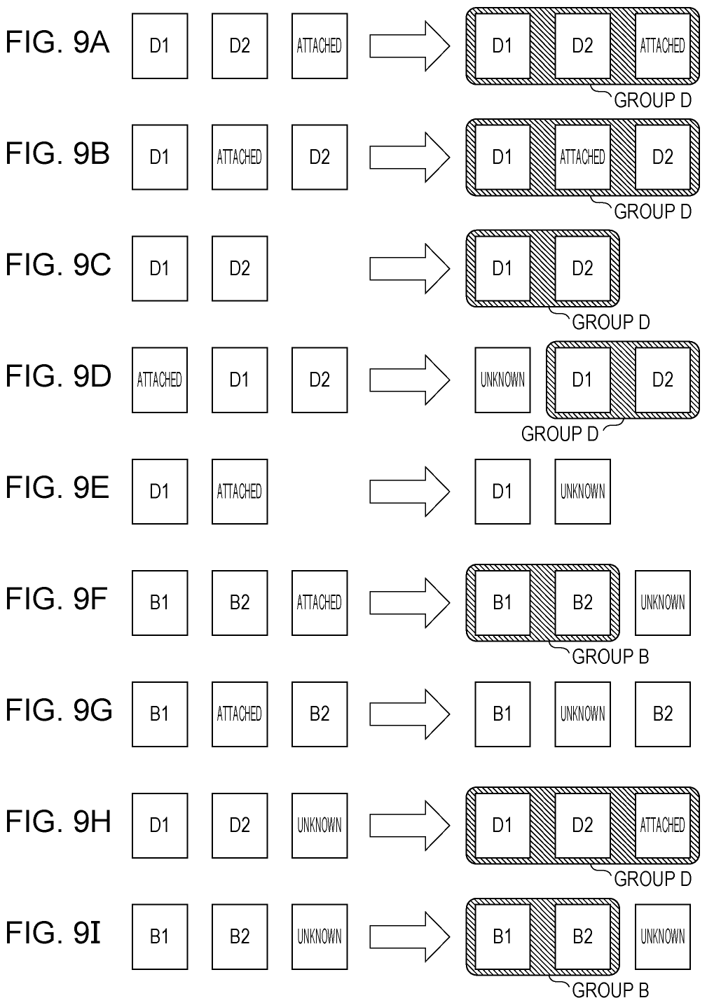

The attached data is data that is attached to a form. If the attribute is an attached file, the form data is the attached file. The grouping of the attached file is described with reference to FIGS. 9A through 9I. In the drawings of the disclosure, the attached file is simply referred to “attached.”

The exclusion flag is used to determine whether a target is to be grouped or not. In the exclusion flag, an on flag represents the state of 1 and an off flag represents the state of 0. The grouping of the form data with the exclusion flag on is described below with reference to FIG. 15.

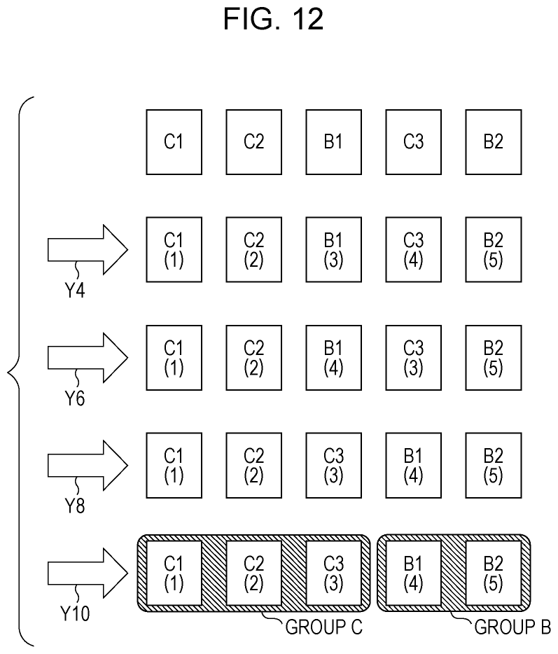

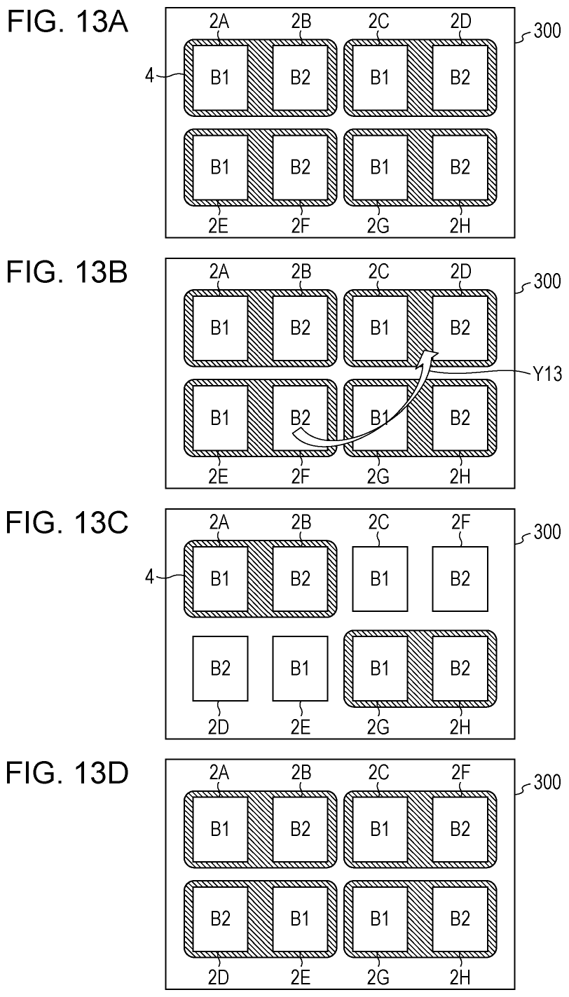

Each piece of the form data is consecutively numbered with a serial number. The numbering and change of the serial number are described below with reference to FIGS. 12 and 13A through 13D. In the drawings of the disclosure, the serial number is parenthesized. For example, “(1)” in the form data C1 (1) in FIG. 12 represents that the serial number of the form data C1 is 1.

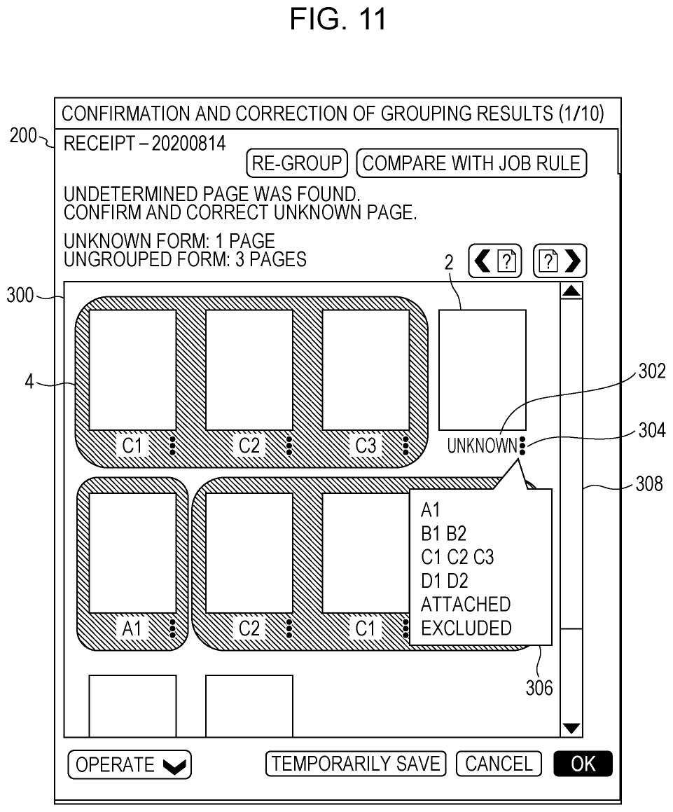

FIG. 2A illustrates 10 form icons 2 arranged in a form display region 300. The form display region 300 displays the form icons 2 and a group region 4. The form display region 300 is displayed on a display 16 to be described below. The form display region 300 will be described more in detail with reference to FIG. 11. The form icon 2 is an image representing the form data. A single form icon 2 corresponds to a single piece of the form data. For example, the form icon 2 denoted “C1” corresponds to form data C1. In order to differentiate each form icon in the discussion that follows, suffixes “A,” “B,” “C,” “D,” “E,” “F,” “G,” “H,” “I,” “J,” and “K” are respectively attached to the form icons. When they are not differentiated, such suffixes are not attached. The group region 4 is a region indicating a group.

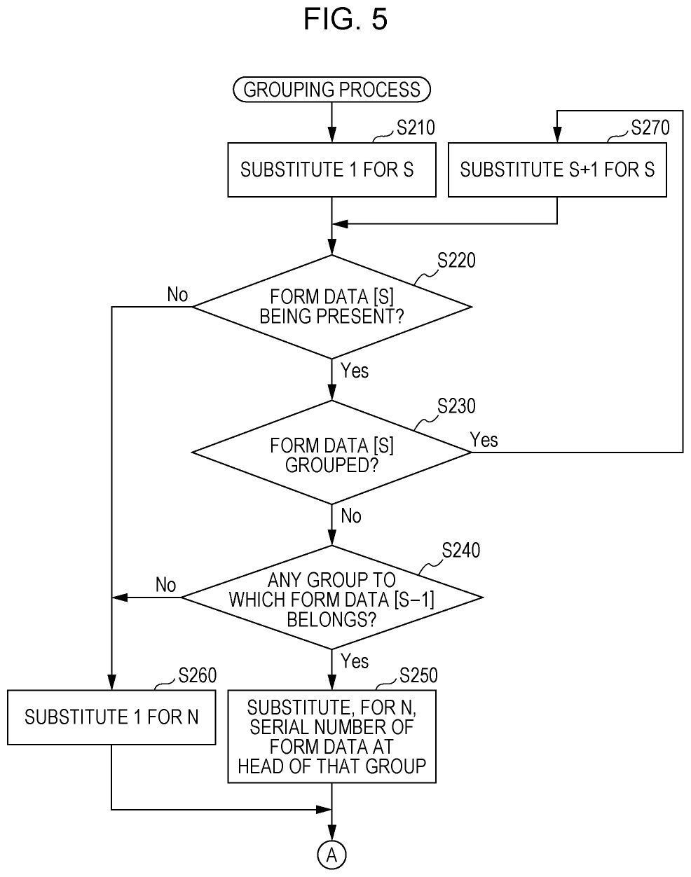

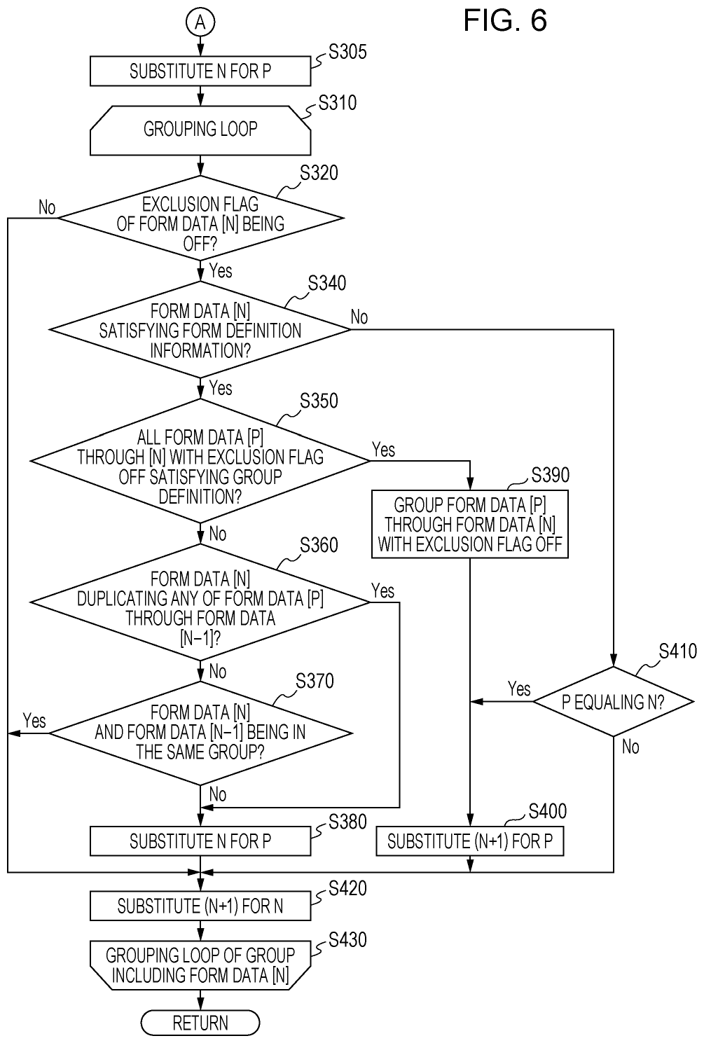

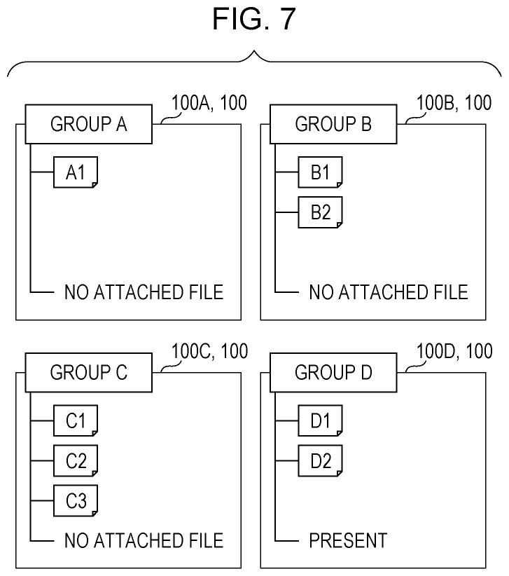

FIG. 2B illustrates the grouping of the form data in FIG. 2A. The information processing apparatus 20 groups the form data in accordance with attributes and the form definition information 100. The form definition information 100 defines each group. Also, the form definition information 100 is one of job rules. A specific example of the form definition information 100 is described with reference to FIG. 7. The procedure of a grouping process is described with reference to FIGS. 5 and 6. The information processing apparatus 20 displays the group region 4 corresponding to each group. Specifically, the form icon 2 arranged in the group region 4 indicates that the form data corresponding to the form icon 2 belongs to the same group. In the discussion that follows, for convenience of explanation, grouping the form data is also described as grouping the form icon 2. Similarly, canceling the grouping of the form data is also described as canceling the grouping of the form icon 2.

FIG. 2C illustrates how a change of the attribute of the form data in FIG. 2B has been received. In the grouping in FIG. 2B, the information processing apparatus 20 receives a change of attribute to ungrouped data. Referring to FIG. 2C, the information processing apparatus 20 has received a change of attribute to the form data at the top right location to change the form class from unknown to C1. The attribute change operation by the user is described with reference to FIG. 11.

FIG. 2D illustrates the grouping that is performed again on the form data in FIG. 2C. The grouping is performed in accordance with the new attribute and the form definition information 100.

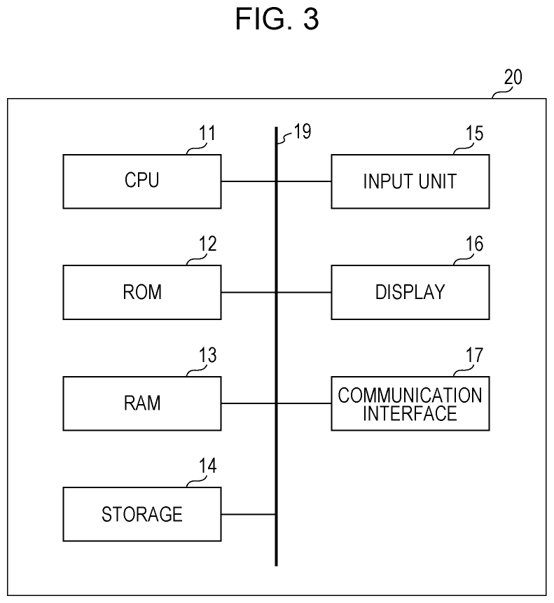

FIG. 3 is a block diagram illustrating a hardware configuration of the information processing apparatus 20. The information processing apparatus 20 includes a central processing unit (CPU) 11, read-only memory (ROM) 12, random-access memory (RAM) 13, storage 14, input unit 15, display 16, and communication interface 17. These elements are interconnected to each other via a bus 19.

The CPU 11 executes a variety of programs and controls each element in the information processing apparatus 20. Specifically, the CPU 11 reads a program from the ROM 12 or the storage 14 and executes the program using the RAM 13 as a working area. In accordance with the program stored on the ROM 12 or the storage 14, the CPU 11 controls the elements and performs a variety of arithmetic processes. According to the exemplary embodiment, an information processing program to execute operations related to the grouping is stored on the ROM 12 or the storage 14. The form definition information 100 is stored on the ROM 12 or the storage 14.

The ROM 12 stores the variety of programs and a variety of data. The RAM 13 temporarily stores the programs or data. The storage 14 includes a hard disk drive (HDD) or a solid-state drive (SSD) and stores a variety of programs including an operating system and a variety of data.

The input unit 15 includes a pointing device, such as a mouse, and a keyboard and is used to enter a variety of inputs. The display 16 is a liquid-crystal display and displays a variety of information. The display 16 may be of a touch panel and also function as the input unit 15.

The communication interface 17 is used to communicate with another apparatus, such as a database, and complies with standards for Ethernet (registered trademark), fiber-distributed data interface (FDDI), and/or Wi-Fi (registered trademark).

The process of the list screen 200 is described below.

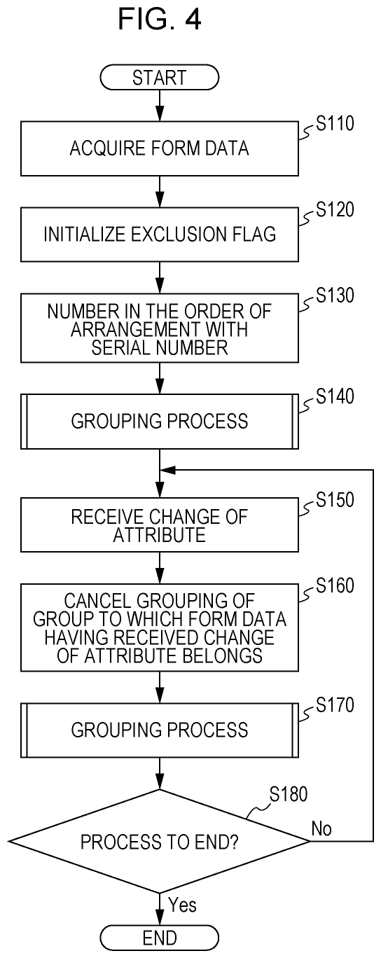

FIG. 4 is a flowchart illustrating a procedure of an grouping process performed by the information processing apparatus 20. The CPU 11 reads the information processing program for the grouping process from the ROM 12 or the storage 14 and expands the information processing program on the RAM 13 to perform the grouping process.

In step S110, the CPU 11 acquires the form data. Specifically, the CPU 11 acquires as the form data the image data that has been determined in the data reading operation (3).

In step S120, the CPU 11 initializes an exclusion flag. The initialization means that the exclusion flag is set to off.

In step S130, the CPU 11 performs each piece of the form data in the order of arrangement with a serial number. For example, the CPU 11 numbers each piece of the form data in the order of acquisition in step S110 with the serial number.

In step S140, the CPU 11 performs the grouping process. The contents of the group processing are described with reference to FIG. 5.

In step S150, the CPU 11 receives a change of an attribute. For example, the CPU 11 receives a change operation to the attribute by a user via the input unit 15. The change operation of the attribute by the user is described with reference to FIG. 11.

In step S160, the CPU 11 cancels the grouping of a group to which the form data having received the change of the attribute therefor belongs.

In step S170, the CPU 11 performs the grouping process. Specifically, the CPU 11 re-groups the form data. The contents of the re-grouping are described with reference to FIG. 5.

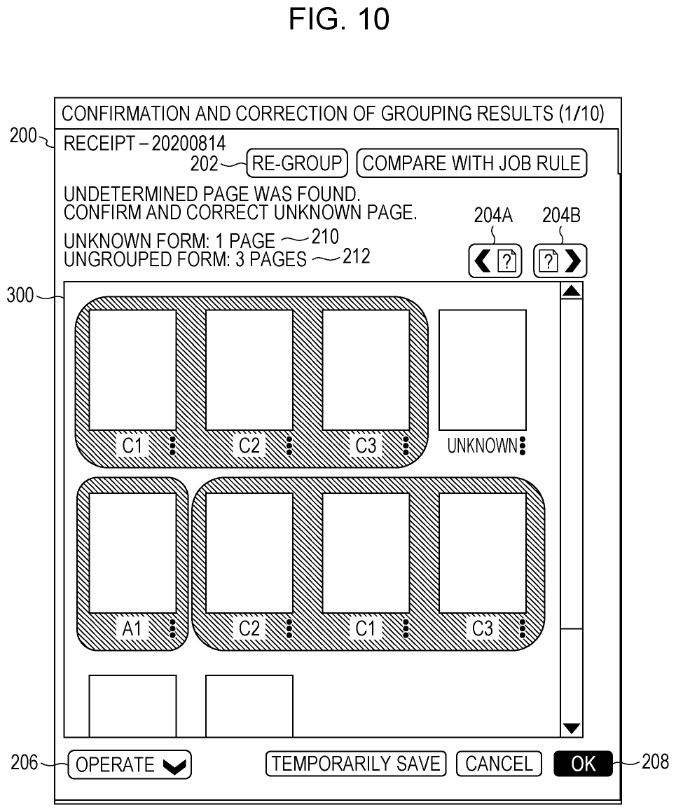

In step S180, the CPU 11 determines whether to end the process. If the CPU 11 determines that the process is to be ended (yes path in step S180), the CPU 11 ends the process. If the CPU 11 determines that the process is not to be ended (no path in step S180), the CPU 11 returns to step S150. For example, if the user clicks an OK button 208 in FIG. 10, the CPU 11 determines that the process is to be ended.

FIGS. 5 and 6 are flowcharts illustrating the procedure of the grouping process performed by the information processing apparatus 20.

In the discussion that follows, S, N, and P represent variables. S is the variable used to determine a start position of the grouping process. N is the variable used as an index in a loop process. P is the variable used as a start position of a grouping determination.

In the discussion that follows, the terms “form data [S]” and “form data [S−1]” are used. The form data [S] represents form data having a serial number S. For example, the form data [S] with S being 3 represents the form data having a serial number 3. The form data [S−1] represents the form data having a serial number being (S−1) (S subtracted by 1). If S is 3, the form data [S−1] is the form data having a serial number 2. The same true of N and P.

Via operations in steps S210 through S270 in FIG. 5, a leading piece of the form data serving as a grouping target is set among multiple pieces of the form data.

In step S210, the CPU 11 substitutes 1 for S.

In step S220, the CPU 11 determines whether form data [S] is present or not. If the form data [S] is present (yes path in step S220), the CPU 11 proceeds to step S230. If the form data [S] is not present (no path in step S220), the CPU 11 proceeds to step S260.

In step S230, the CPU 11 determines whether the form data [S] is grouped. If the form data [S] is determined to be not grouped (no path in step S230), the CPU 11 proceeds to step S240. If the form data [S] is determined to be grouped (yes path in step S230), the CPU 11 returns to step S270.

In step S240, the CPU 11 determines whether any group with the form data [S−1] belonging thereto is present. If any group with the form data [S−1] belonging thereto is present (yes path in step S240), the CPU 11 proceeds to step S250. If the CPU 11 determines that any group with the form data [S−1] belonging thereto is not present (no path in step S240), the CPU 11 proceeds to step S260.

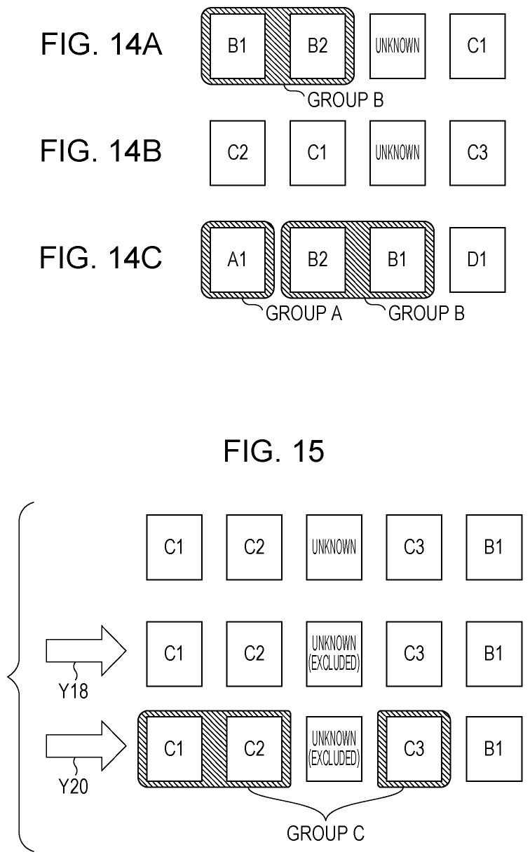

In step S250, the CPU 11 substitutes for N the serial number of a leading piece of the form data of the group. The group is a group to which the form data [S−1] belongs. Specifically, the CPU 11 substitutes for N the serial number of the leading piece of the form data of the group to which the form data [S−1] belongs. This is specifically described with reference to FIGS. 14A through 14C.

In step S260, the CPU 11 substitutes 1 for N.

In step S270, the CPU 11 substitutes (S+1) for S.

Via operations in steps S310 through S430 in FIG. 6, the form data serving as a grouping target is grouped.

In step S305, the CPU 11 substitutes N for P.

In step S310, the CPU 11 starts an iteration process of the grouping loop. The CPU 11 determines whether to iterate the grouping loop in step S430.

In step S320, the CPU 11 determines whether the exclusion flag of form data [N] is off. If the exclusion flag of the form data [N] is determined to be off (yes path in step S320), the CPU 11 proceeds to step S340. If the exclusion flag of the form data [N] is determined to be on (no path in step S320), the CPU 11 proceeds to step S420.

In step S340, the CPU 11 determines whether the form data [N] satisfies the form definition information 100. If the form data [N] is determined to satisfy the form definition information 100 (yes path in step S340), the CPU 11 proceeds to step S350. If the form data [N] is determined to not meet the form definition information 100 (no path in step S340), the CPU 11 proceeds to step S410. The form data [N] not satisfying the form definition information 100 means that the form data [N] is an unknown form.

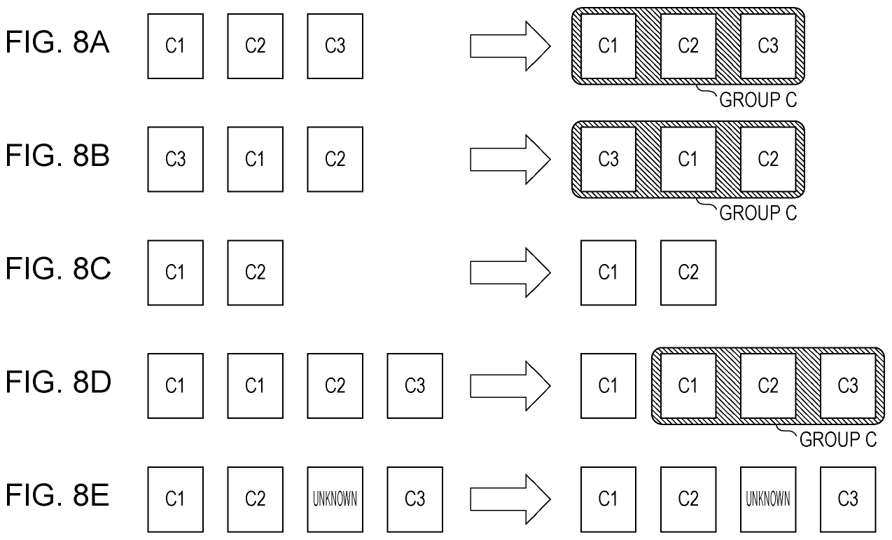

In step S350, the CPU 11 determines whether all the form data [P] through [N] with exclusion flags thereof being off satisfy the definition of the group. If all the form data [P] through [N] with exclusion flags thereof being off are determined to not satisfy the definition of the group (no path in step S350), the CPU 11 proceeds to step S360. If all the form data [P] through [N] with exclusion flags thereof being off are determined to satisfy the definition of the group (yes path in step S350), the CPU 11 proceeds to step S390. A specific example of all the form data satisfying the definition of the group is described below with reference to FIG. 8A. A specific example of all the form data not satisfying the definition of the group is described below with reference to FIG. 8C.

In step S360, the CPU 11 determines whether the form data [N] duplicates any of form data [P] through [N−1]. The word duplicate means that one piece of the form data is identical another piece of the form data in form class. If the CPU 11 determines that the form data [N] does not duplicate any of form data [P] through [N−1] (no path in step S360), the CPU 11 proceeds to step S370. If the CPU 11 determines that the form data [N] duplicates any of form data [P] through [N−1] (yes path in step S360), the CPU 11 proceeds to step S380. The duplication example is described with reference to FIG. 8D.

In step S370, the CPU 11 determines whether the form data [N] and the form data [N−1] are in the same group. If the CPU 11 determines that the form data [N] and the form data [N−1] are not in the same group (no path in step S370), the CPU 11 proceeds to step S380. If the CPU 11 determines that the form data [N] and the form data [N−1] are in the same group (yes path in step S370), the CPU 11 proceeds to step S420.

In step S380, the CPU 11 substitutes N for P. Specifically, if the CPU 11 determines that the form data [N] duplicates any of form data [P] through [N−1] (yes path in step S360) or that the form data [N] and the form data [N−1] are not in the same group (not path in step S370), the start position of the grouping determination is set to the form data [N].

In step S390, the CPU 11 groups the form data [P] through the form data [N] with the exclusion flags thereof being off.

In step S400, the CPU 11 substitutes (N+1) for P.

In step S410, the CPU 11 determines whether P equals N. If the CPU 11 determines that P equals N (yes path in step S410), the CPU 11 proceeds to step S400. If the CPU 11 determines that P does not equal N (no path in step S410), the CPU 11 proceeds to step S420. P equaling N means that the start position of the grouping determination is an unknown form.

In step S420, the CPU 11 substitutes (N+1) for N.

In step S430, the CPU 11 determines whether the form data [N] is present. If the CPU 11 determines that the form data [N] is present, the CPU 11 returns to step S310. If the CPU 11 determines that the form data [N] is not present, the CPU 11 ends the grouping process.

FIG. 7 illustrates an example of the form definition information 100 on the information processing apparatus 20 of the exemplary embodiment. The form definition information 100 defines the form class on a per group basis and the presence or absence of an attached file. If an attached file is present, an “attached file present” is specified. If no file is attached, “no attached file” is specified. The form definition information 100A defines a group A. Similarly, the form definition information 100B, the form definition information 100C, and the form definition information 100D respectively define a group B, group C, and group D. The group A means that the form class is A1 with no attached file. The group B means that the form class includes B1 and B2 with no file attached. The group C means that the form class includes C1, C2, and C3 with no attached file. The group D means that the form class includes D1 and D2 with an attached file present. To differentiate each piece of the form definition information, codes “A,” “B,” “C,” and “D” differentiating one piece from another are attached. Such codes are not attached if the form definition information is not differentiated.

FIGS. 8A through 8E illustrate examples of the grouping of the form data with no file attached on the information processing apparatus 20 of the exemplary embodiment. The group data to the right of arrow marks is prior to grouping and the group data to the left of the arrow marks is subsequent to grouping. FIGS. 8A through 8E correspond to the grouping process in step S140 or S170.

The form data C1, form data C2, and form data C3 are arranged in this order in FIG. 8A. The grouping condition that the definition of the group is satisfied. All these pieces of the form data satisfying the definition of the group C are thus grouped as the group C.

The form data C3, form data C1, and form data C2 are arranged in this order in FIG. 8B. The grouping condition is not based on the order of arrangement of the form data. All these pieces of the form data satisfying the definition of the group C are thus grouped as the group C.

The form data C1 and form data C2 are arranged in this order in FIG. 8C. Since the form data C3 is not present, these pieces of the form data are not grouped.

The form data C1, form data C1, form data C2, and form data C3 are arranged in this order in FIG. 8D. The grouping condition is that only one type of form class is permitted. Because of this grouping condition, the first form data C1 is grouped.

The form data C1, form data C1, form data C2, unknown form and form data C3 are arranged in this order in FIG. 8E. The grouping condition is that the group C does not include a form class that is not defined. These pieces of the form data are thus not grouped.

FIGS. 9A through 9I illustrate the grouping of the form data with an attached file present on the information processing apparatus 20 of the exemplary embodiment. The group data to the right of arrow marks is prior to grouping and the group data to the left of the arrow marks is subsequent to grouping. FIGS. 9A through 9I correspond to the grouping process in step S140 or S170.

The form data D1, form data D2, and attached file are arranged in this order in FIG. 9A. All these pieces of the form data satisfying the definition of the group D are grouped as the group D.

The form data D1, attached file, and form data D2 are arranged in this order in FIG. 9B. All these pieces of the form data satisfying the definition of the group D are grouped as the group D.

The form data D1 and form data D2 are arranged in this order in FIG. 9C. The attached file present means that the grouping is conditioned on zero or more attached files. In other words, even with no attached file, the form data may be grouped. All these pieces of the form data satisfying the definition of the group D are grouped as the group D.

The attached file, form data D1, and form data D2 are arranged in this order in FIG. 9D. The grouping condition is that the attached file is arranged at any location other than the head of the form data. The attached file arranged at the head is not grouped. The information processing apparatus 20 changes the ungrouped attached file to an unknown form.

The form data D1 and attached file are arranged in this order in FIG. 9E. Since the form data D2 is not present, these pieces of the form data are not grouped as the group D.

Form data B1, form data B2, and attached file are arranged in this order in FIG. 9F. The attached file is not to be included in the group B and is thus not grouped.

The form data B1, attached file, and form data B2 are arranged in this order in FIG. 9G. These pieces of the form data are not grouped since the group B is to be without attached file.

The form data D1, form data D2, and unknown form are arranged in this order in FIG. 9H. In the grouping, the information processing apparatus 20 regards the unknown file as an attached file. All these pieces of the form data satisfying the definition of the group D are grouped as the group D. If the information processing apparatus 20 has grouped the unknown form as an attached file, the information processing apparatus 20 changes the attribute of the unknown form to the attached file. If the information processing apparatus 20 does not group the unknown form as an attached file, the information processing apparatus 20 does not change the attribute of the unknown form to an attached file.

The form data B1, form data B2, and unknown form are arranged in this order in FIG. 9I. Since the group B is to be without attached file, the unknown file is not grouped.

FIGS. 10 and 11 illustrate examples of list screens 200 on the display 16 in the information processing apparatus 20 of the exemplary embodiment. The list screen 200 includes a variety of buttons and a variety of display regions.

The list screen 200 is described with reference to FIG. 10. The buttons include a re-group button 202, back button 204A, next button 204B, operate button 206, and OK button 208. The display regions include an unknown form count display region 210, ungrouped form data count display region 212, and form display region 300. The buttons respond to a click operation performed on a mouse as the input unit 15.

When the user clicks the re-regroup button 202, the information processing apparatus 20 groups the form data.

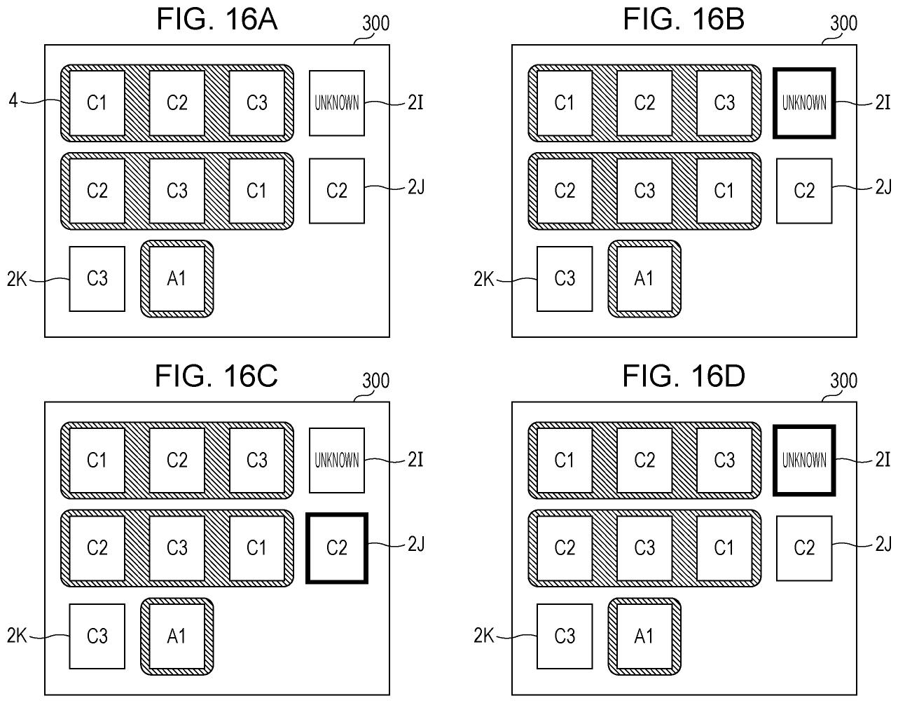

When the user clicks the back button 204A or the next button 204B, the information processing apparatus 20 successively focuses on the ungrouped form icons 2. The click operation of the back button 204A focuses on a preceding ungrouped icon 2, shifting from the currently focused form icon 2. The click operation of the next button 204B focuses on a next ungrouped form icon 2, shifting from the currently focused form icon 2. This operation is specifically described below with reference to FIGS. 16A through 16D.

When the user clicks the operate button 206, the information processing apparatus 20 displays operation candidates including re-operate operation by specifying a reset operation and the form definition information.

When the user selects the reset operation, the information processing apparatus 20 reverts the form data to a state before the change of the attribute is received. By performing the reset operation, the user may start over again.

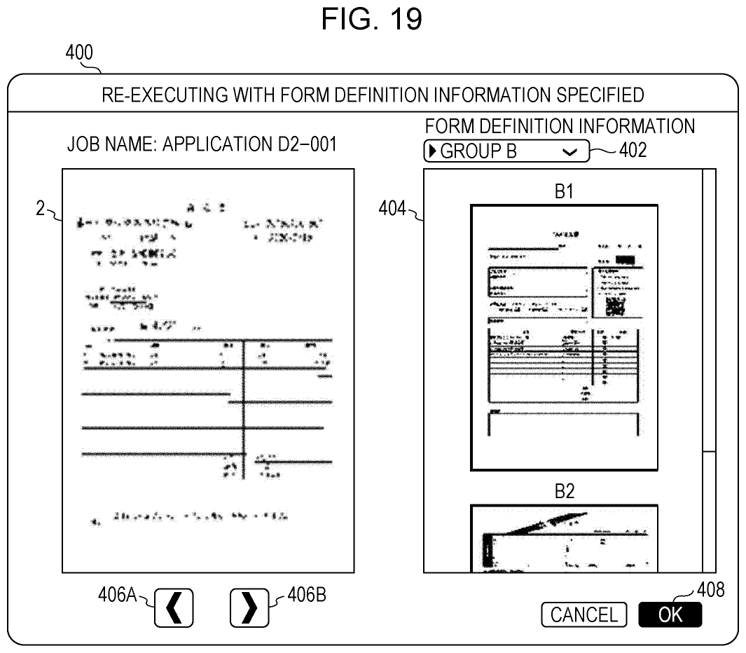

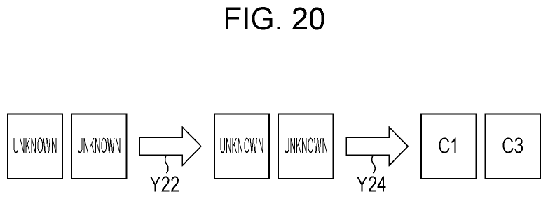

When the user selects the re-execute operation by specifying the form definition information, the information processing apparatus 20 displays a modification screen 400. The re-execute operation performed by specifying the form definition information is described below with reference to FIG. 20. The modification screen 400 is described below with reference to FIG. 19.

If the OK button 208 is clicked, the information processing apparatus 20 ends the grouping process.

The unknown form count display region 210 displays the number of unknown forms out of the form data.

The ungrouped form data count display region 212 displays the number of ungrouped pieces of the form data.

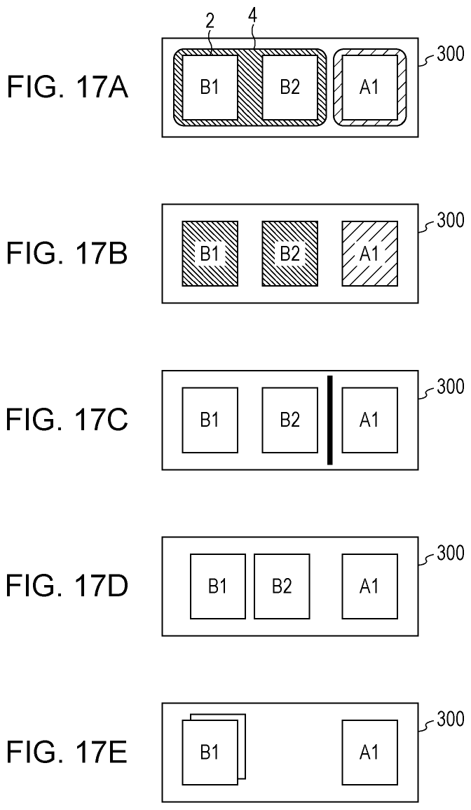

Referring to FIG. 11, an example of the form display region 300 is described. The form display region 300 display the form icons 2 and the group regions 4. The form display region 300 displays the form icons 2 in a list. For example, the form icon 2 may be an image or a thumbnail corresponding to the form data. A specific example of the group region 4 is described below with reference to FIGS. 17A through 17E. The form display region 300 includes an attribute display region 302, attribute change button 304, attribute candidate display region 306, and scroll bar 308.

The attribute display region 302 displays an attribute of the form data. For example, if the form icon 2 is displayed in a thumbnail of the form data, the attribute display region 302 displays the form class of the form data. The word “unknown” of the unknown form may be displayed in red.

When the user clicks the attribute change button 304, the information processing apparatus 20 displays the attribute candidate display region 306.

The attribute candidate display region 306 displays substitute attributes. The substitute attributes include a form class, attached file, and exclusion flag used on the form definition information 100. If an attribute is selected, the attribute of the form data is changed to the selected attribute. The word “unknown” may be displayed to indicate an “unknown form.”

When the user scrolls the scroll bar 308, the information processing apparatus 20 scrolls a display region of the form display region 300.

FIG. 12 illustrates an example of a change of a serial number on the information processing apparatus 20 of the exemplary embodiment. Referring to FIG. 12, the form data C1, form data C2, form data B1, form data C3, and form data B2 are arranged in this order. FIG. 12 corresponds to the operation in step S150 described above.

An arrow mark Y4 indicates an operation to number the form data in the order of arrangement with serial numbers. The form data is thus successively numbered with serial numbers 1, 2, 3, 4, and 5. The operation denoted by the arrow mark Y4 corresponds to the operation in step S130.

An arrow mark Y6 denotes an operation to change the serial number. The information processing apparatus 20 changes the serial number of the form data B1 from 3 to 4 and the serial number of the form data C3 from 4 to 3. Upon receiving a change operation from the user, the information processing apparatus 20 changes the serial number. A specific example of the change operation is described below with reference to FIG. 13.

An arrow mark Y8 denotes an re-arrangement operation to re-arrange the form data in the order of the serial numbers. The information processing apparatus 20 re-arranges the form data in the order of the form data C1, form data C2, form data C3, form data B1, and form data B2.

An arrow mark Y10 denotes the grouping process. The information processing apparatus 20 groups the form data C1, form data C2, and form data C3 as the group C. Similarly, the information processing apparatus 20 groups the form data B1 and form data B2 as the group B.

FIGS. 13A through 13D illustrate an example of the change operation of the serial numbers performed by the information processing apparatus 20 of the exemplary embodiment. FIG. 13 corresponds to the operation in step S150 described above.

FIG. 13A illustrates form icons 2A, 2B, 2C, 2D, 2E, 2F, 2G, and 2H arranged in this order. The form classes corresponding to the form icons are B1, B2, B1, B2, B1, B2, B1, and B2 in this order. The form icon 2A and the form icon 2B are grouped together. Similarly, the form icon 2C is grouped together with the form icon 2D, the form icon 2E is grouped together with the form icon 2F, and the form icon 2G is grouped together with the form icon 2H.

FIG. 13B illustrates the movement of the form icon 2F into between the form icon 2C and the form icon 2D among the form icons 2 in FIG. 13A. For example, the information processing apparatus 20 moves the form icon 2F via a drag-and-drop operation as denoted by an arrow mark Y13 by using a mouse as the input unit 15.

FIG. 13C illustrates the form icons 2 after the form icons 2 in FIG. 13B are moved. The form icons 2A, 2B, 2C, 2F, 2D, 2E, 2G, and 2H are arranged in this order. The information processing apparatus 20 cancels the grouping of the groups to which the moved icons 2 belong. The cancelation of the grouping refers to cancelation of the grouping of all the form data belonging to that group. Specifically, the information processing apparatus 20 cancels the grouping of the group including the form icon 2D and the group including the form icons 2E and 2F.

FIG. 13D illustrates how the form icons 2 in FIG. 13C are re-grouped in the order of arrangement after the movement. The form icons 2A and 2B are grouped together. Similarly, the form icons 2C grouped together with the form icon 2F, the form icon 2D is grouped together with the form icon 2E, and the form icon 2G is grouped together with the form icon 2H.

FIGS. 14A through 14C illustrate an example of a start position of re-grouping performed by the information processing apparatus 20 of the exemplary embodiment. The information processing apparatus 20 sets to be a start position a leading piece of the form data belonging to a group immediately prior to a leading piece of the ungrouped form data. The information processing apparatus 20 groups the form data starting with the form data at the start position. FIGS. 14A through 14C illustrate the operations in steps S210 through S270.

FIG. 14A illustrates the form data B1, form data B2, unknown form, and form data C1 arranged in this order. The form data B1 and the form data B2 are grouped together as the group B. The leading piece of the ungrouped form data is an unknown form. The group immediately prior to the unknown form is the group B to which the form data B2 belongs. The leading piece of the form data in the group B is the form data B1. Referring to FIG. 14A, the start position of the grouping is the form data B1.

FIG. 14B illustrates the form data C2, form data C1, unknown form, and form data C3 arranged in this order. These pieces of data are not grouped. A leading piece of the ungrouped form data is the form data C2. The group immediately prior to the form data C2 is not present. Referring to FIG. 14B, the start position of the grouping is the form data C2.

FIG. 14C illustrates the form data A1, form data B2, form data B1, and form data D1 arranged in this order. The form data A1 is grouped as the group A. The form data B2 and the form data B1 are grouped as the group B. The leading piece of the ungrouped form data is the form data D1. The group immediately prior to the form data D1 is the group B to which the form data B1 belongs. The leading piece of the group B is the form data B2. Referring to FIG. 14C, the start position of the grouping is the form data B2.

FIG. 15 illustrates the grouping of the form data with the exclusion flag being on in the information processing apparatus 20 of the exemplary embodiment. FIG. 15 illustrates the form data C1, form data C2, unknown form, form data C3, and form data B1 arranged in this order. FIG. 15 corresponds to the operation in step S320.

An arrow mark Y18 denotes an operation to set the exclusion flag to on. Upon receiving an operation to change the exclusion flag, the information processing apparatus 20 sets the exclusion flag to on. The operation to change the exclusion flag is user operation to select an “exclude” in the attribute candidate display region 306 as illustrated in FIG. 11. The information processing apparatus 20 may display an “x” mark on the form icon 2 with the exclusion flag on.

An arrow mark Y20 denotes the grouping. The form data C1, form data C2, form data C3, and form data B1 with the exclusion flag thereof being off serve as targets of the grouping. The information processing apparatus 20 groups the form data C1, form data C2, and form data C3 as the group C.

FIGS. 16A through 16D illustrate an example of operations of a back button and next button on the information processing apparatus 20 of the exemplary embodiment. The ungrouped form icons 2 are successively focused on. For example, the information processing apparatus 20 makes thicker the frame line of the form icon 2 in focus.

FIG. 16A illustrates multiple form icons 2 arranged. The ungrouped form icons 2 include a form icon 2I, form icon 2J, and form icon 2K in this order. Referring to FIG. 16A, none of these icons is not focused on.

FIG. 16B illustrates an next ungrouped form icon 2 that is focused on in response to the click operation of the next button 204B among the form icons 2 in FIG. 16A. None of the form icons 2 is focused on in FIG. 16A, and the leading form icon 2I out of the ungrouped form icons 2 is focused on in FIG. 16A.

FIG. 16C illustrates another next ungrouped form icon 2 that is focused on in response to the click operation of the next button 204B among the form icons 2 in FIG. 16B. The form icon 2I is focused on in FIG. 16B, and the form icon 2J is focused on as a next ungrouped form icon 2 in FIG. 16C.

FIG. 16D illustrates the preceding ungrouped form icon 2 that is focused on in response to the click operation of the back button 204A among the form icons 2 in FIG. 16C. The form icon 2J is focused on in FIG. 16C, and the form icon 2I is focused on as the preceding ungrouped form icon 2 in FIG. 16D.

FIGS. 17A through 17E illustrate an example of a method that expresses groups together on the information processing apparatus 20 of the exemplary embodiment. Referring to FIGS. 17A through 17E, the form data B1, form data B2, and form data A1 are arranged in this order. The form data B1 and form data B2 are grouped together. The form data A1 is grouped. Referring to FIGS. 17A through 17E, the form data and groups are displayed as the form icons 2 and the group regions 4 in the form display region 300.

FIG. 17A illustrates the group regions 4, each of which is a contiguous region. The information processing apparatus 20 may color the group regions 4. The information processing apparatus 20 may color differently each group region 4 one region from another.

FIG. 17B illustrates the form icons 2 that are differently colored from one group to another.

FIG. 17C illustrates a partition arranged between adjacent groups.

FIG. 17D illustrates the form data in which the spacing between the form icons 2 belonging to the same group is set to be narrower than the spacing between the form icons 2 not belonging to the same group.

FIG. 17E illustrates the form icons 2 overlapped on each other on a per group basis.

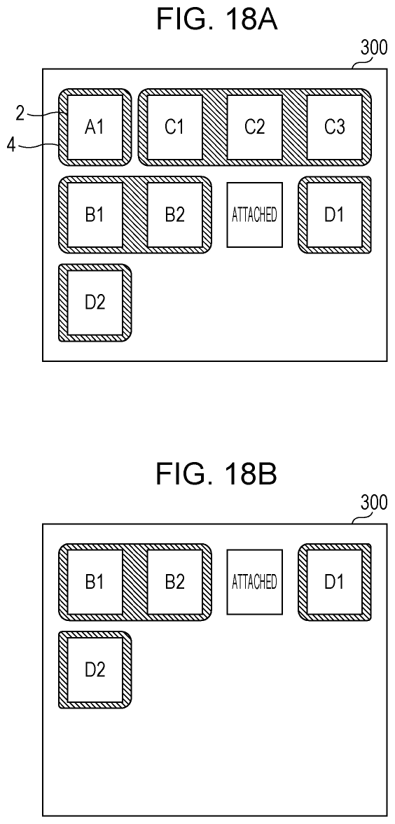

FIGS. 18A and 18B illustrate a display example of the groups on the information processing apparatus 20 of the exemplary embodiment. The information processing apparatus 20 does not display the form icons 2 belonging to a group that is adjacent to another group.

Referring to FIG. 18A, the form data A1, form data C1, form data C2, form data C3, form data B1, form data B2, attached file, form data D1, and form data D2 are arranged in this order. The form data A1 is grouped as the group A. The form data C1 and form data C3 are grouped as the group C. The form data B1 and form data B2 are grouped as the group B. Referring to FIG. 18A, the form data and groups are displayed as the form icons 2 and the group regions 4 in the form display region 300.

FIG. 18B does not illustrate the form icons 2 belonging to the group A or the group C among the form icons 2 in FIG. 18A. The group A is adjacent to only the group C. The group C is adjacent to the group A and group C. The group B is adjacent to the group C and attached file. The information processing apparatus 20 does not display the form data A1 belonging to the group A or the form data C1, the form data C2, and the form data C3 belonging to the group C.

FIG. 19 illustrates an example of the modification screen 400 on the display 16 on the information processing apparatus 20 of the exemplary embodiment. The modification screen 400 includes, the form icons 2, a variety of buttons and a variety of display regions.

The buttons include a turn back button 406A, turn next button 406B, and enter button 408. The display regions include a form definition information selection region 402 and form definition information display region 404. The buttons respond to a click operation performed on a mouse serving as the input unit 15.

The form definition information selection region 402 displays definition of a pre-registered group. The information processing apparatus 20 receives the definition of the group selected by the user and displays the contents of the definition on the form definition information display region 404. For example, the form definition information selection region 402 displays as a choice the group A, group B, group C, and group D. FIG. 19 illustrates the definition of the group B selected.

The form definition information display region 404 displays the contents of the definition of the selected group. For example, the contents of the definition of the group are an image corresponding to the form class defined for the group. Referring to FIG. 19, the contents of the definition of the group B are displayed.

If the user clicks the turn back button 406A or the turn next button 406B, the information processing apparatus 20 successively switches and displays the form icons 2 from one icon to another. Referring to FIG. 19, the form icon 2 represents the image corresponding to the form data.

If the user clicks the enter button 408, the information processing apparatus 20 performs modification to add the definition of the selected group to the form definition information 100. The information processing apparatus 20 then re-groups in accordance with the modified form definition information 100. If the form definition information 100 is modified, the information processing apparatus 20 may be free from re-reading information on the image data.

FIG. 20 illustrates an example of a re-grouping process the information processing apparatus 20 of the exemplary embodiment performs in accordance with the modified form definition information 100. Referring to FIG. 20, the form definition information 100 defines the group A and group B. In FIG. 20, the form data C1 and the form data C3 are arranged in this order. However, since the group C is not defined in the form definition information 100, they are arranged as unknown forms.

An arrow mark Y22 denotes the grouping. Since the group C is not defined in the form definition information 100, the unknown forms are arranged as they are.

An arrow mark Y24 denotes the re-grouping performed after the modification of the form definition information 100. The modification of the form definition information 100 is adding the definition of the group C to the form definition information 100. Since the form definition information 100 after being modified defines the group C, the unknown forms are arranged as the form data C1 and form data C3.

The information processing apparatus 20 of the exemplary embodiment has been described. The disclosure is not limited to the exemplary embodiment. A variety of changes or modifications is possible to the exemplary embodiment.

The algorithm of the grouping process is not limited to step S140 in FIG. 4. The form definition information 100 is not limited to the information illustrated in FIG. 7. The information processing apparatus 20 may define a group as multiple and identical form classes or define a group according to the type of form rather than the form class. The grouping process is not limited to the procedures illustrated in FIGS. 8A through 8E and FIGS. 9A through 9I.

The number of attached files present may not necessarily be zero or more for grouping. For example, the information processing apparatus 20 may use one attached file present for grouping. In such a case, the form data D1 and form data D2 in FIG. 9C are difficult to be grouped because of the lack of attached file.

Referring to FIG. 11, the information processing apparatus 20 may receive a change of attribute for the grouped form data. If the grouped form data is modified, the information processing apparatus 20 may cancel the grouping of a group including that form data. Along with the canceling of the grouping of the group, the information processing apparatus 20 may delete the group region 4.

The change operation is not limited to the drag-and-drop operation in FIG. 13. The information processing apparatus 20 may receive a simple number as a serial number.

Referring to FIGS. 14A through 14C, the information processing apparatus 20 may set the leading piece of the form data to the start position of the grouping. Alternatively, the information processing apparatus 20 may set to the start position of the grouping a leading piece of form data belonging to a group several minutes earlier than a leading piece of the present form data.

The processes described above may be implemented by using dedicated hardware. In such a case, the processes may be implemented by using one or more pieces of hardware.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The program causing the information processing apparatus 20 to operate may be provided on a computer-readable recording medium or online via a network, such as the Internet. The computer-readable recording media include a universal serial bus (USB), flexible disk, compact disc read only memory (CD-ROM). The program recorded on the computer-readable recording medium is typically transferred to and stored on a memory or storage. The program may be a single piece of application software or may be built in software in each device operating as a function of the information processing apparatus 20.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
with a plurality of pieces of form data having attributes of forms being grouped in accordance with form definition information that defines groups respectively with the attributes, receive a change of an attribute of an ungrouped piece of the form data; and
re-group the form data in accordance with an attribute responsive to the change and the form definition information.

2. The information processing apparatus according to claim 1, wherein the processor is configured to:
number the pieces of the form data in an order of arrangement with serial numbers serving as one of the attributes; and
group the form data in an order of the serial numbers.

3. The information processing apparatus according to claim 2, wherein the processor is configured to re-group ungrouped pieces of the form data by starting with a leading ungrouped piece of the form data in the order of arrangement.

4. The information processing apparatus according to claim 3, wherein the processor is configured to re-group form data belonging to a group immediately prior to the leading ungrouped piece of the form data by starting with a leading piece of the form data belonging to the group.

5. The information processing apparatus according to claim 1, wherein the processor is configured to:
display the form data in a list; and
receive in the list the change of the attribute with respect to each ungrouped piece of the form data.

6. The information processing apparatus according to claim 2, wherein the processor is configured to:
display the form data in a list; and
receive in the list the change of the attribute with respect to each ungrouped piece of the form data.

7. The information processing apparatus according to claim 3, wherein the processor is configured to:
display the form data in a list; and
receive in the list the change of the attribute with respect to each ungrouped piece of the form data.

8. The information processing apparatus according to claim 4, wherein the processor is configured to:
display the form data in a list; and
receive in the list the change of the attribute with respect to each ungrouped piece of the form data.

9. The information processing apparatus according to claim 5, wherein the processor is configured to display the form data together if the form data belongs to a same group.

10. The information processing apparatus according to claim 6, wherein the processor is configured to display the form data together if the form data belongs to a same group.

11. The information processing apparatus according to claim 7, wherein the processor is configured to display the form data together if the form data belongs to a same group.

12. The information processing apparatus according to claim 8, wherein the processor is configured to display the form data together if the form data belongs to a same group.

13. The information processing apparatus according to claim 5, wherein the processor is configured to not display the form data belonging to a group that is adjacent to another group.

14. The information processing apparatus according to claim 6, wherein the processor is configured to not display the form data belonging to a group that is adjacent to another group.

15. The information processing apparatus according to claim 7, wherein the processor is configured to not display the form data belonging to a group that is adjacent to another group.

16. The information processing apparatus according to claim 1, wherein the attributes comprise information indicating that the form data is an attached file, and
wherein the processor is configured to group the form data in accordance with the form definition information that defines presence or absence of the attached file on a per group basis.

17. The information processing apparatus according to claim 16, wherein the processor is configured to, by regarding the form data as the attached file, group form data that is unknown in term of form type serving as one of the attributes.

18. The information processing apparatus according to claim 1, wherein the processor is configured to:
receive a setting change to an exclusion flag serving as one of the attributes; and
re-group the form data having an exclusion flag being off.

19. The information processing apparatus according to claim 1, wherein the processor is configured to:
receive a change of an attribute for a grouped piece of the form data; and
cancel grouping of a group to which the form data having received the change belongs.

20. A non-transitory computer readable medium storing a program causing a computer to execute a process for processing information, the process comprising:
with a plurality of pieces of form data having attributes of forms being grouped in accordance with form definition information that defines groups respectively with the attributes, receiving a change of an attribute of an ungrouped piece of the form data; and
re-grouping the form data in accordance with an attribute responsive to the change and the form definition information.
